(19) United States
(12) Patent Application Publication
(10) Pub. No.: US 2006/0049956 A1
(43) Pub. Date: Mar. 9, 2006

(54) Explosion-proof multi-status multi-color visual indicator

(75) Inventors: Kenneth R. Taylor, Ivoryton, CT (US); Scott Greco, Middletown, CT (US); Angelo S. Arcaria, Wethersfield, CT (US)

Correspondence Address: BAKER & HOSTETLER LLP, Washington Square, Suite 1100, 1050 Connecticut Avenue, N.W., Washington, DC, 20036, US

(73) Assignee: Edwards Systems Technology, Inc.

(21) Appl. No.: 10/936,791

(22) Filed: Sep. 9, 2004

(51) Int. Cl. G08B 5/36; G08B 3/00

(52) U.S. Cl. 340/815.67; 340/815.76; 340/691.6

(57) ABSTRACT

An explosion-proof industrial signaling device. The explosion-proof industrial signaling device having an explosion-proof housing and a single module with the capability of emitting different colored lights to indicate the operating condition of a machine. The emitted light can be steady or flashing, and controlled by an external PLC or an onboard microprocessor. The PLC or microprocessor interprets incoming information and causes the color of the light or its flashing pattern to change accordingly. The light source maybe an LED.

### FIELD OF THE INVENTION

The present invention relates generally to signaling devices used in Class I, Division I explosion-proof hazardous locations, and more particularly, to visual signaling devices that emit attention attracting light signals, and yet retain their various color identification.

### BACKGROUND OF THE INVENTION

Studies of light signaling devices used in industrial and commercial areas as well as on industrial equipment show that effective warning is best accomplished by signaling devices, which combine a bright visual light signal with high color identification. Color identification is highly desirable in light signaling devices because red, blue, green, and amber colored light signals have long become associated with stop, start, warning, and waiting indication in industrial and commercial application.

Elevated industrial signaling devices are well known in factory-type environments where numerous industrial machines are present. Generally, such industrial signaling devices are mounted on a pole so they are high above each machine and clearly visible from a distance. Each device typically has a plurality of modules that emit differently colored light for visually signaling the operating status of each machine.

In a typical signaling device, each of the lights is responsive to an operating status of the machine to which the device is connected. For example, a typical device has lights of various colors such as, blue, red, amber and green. Each of the these differing colors is contained in a discrete module. The differing colors of the lights correspond to various operating stages of the machine. For example, a blue light may indicate the machine is running correctly, an amber light may indicate that the machine is in need of service and a red light may indicate that the machine has ceased operating. The colors of the lights are very important because even at a distance an illuminated light of one color is immediately distinguishable from the other lights of different colors.

FEDERAL SIGNAL of University Park, Illinois has Model 121X which is a rotating light which flashes 90 times per minute and produces a 360° visual signal. This explosion-proof light has an incandescent lamp and is available in five separate lens colors—amber, blue, clear, green and red. This device is ideal for use in indoor and outdoor areas such as oil rigs, mines refineries, and chemical plants.

FEDERAL SIGNAL also has a Model FB2PSTX explosion-proof strobe light which is a compact unit that produces a “lightening bolt” flash of light. This device has an outer dome made of tempered glass. Polycarbonate inner lenses are available in amber, blue, clear, green and red.

FEDERAL SIGNAL has a Model 27XST which is an explosion-proof strobe light which produces 80 high-intensity flashes per minute. This device is also ideal for use in areas such as oil rigs, mines, refineries, and chemical plants. The interior lens of this device is available in amber, blue, clear, green, red and magenta.

It should be noted however, that none of the above-noted FEDERAL SIGNAL devices is capable of multiple color displays without the need for a colored interior lens.

Another examples of these devices is U.S. Pat. No. 5,103,215 to James et. al which discloses a signaling light made from a plurality of differently colored vertically stacked modules with incandescent lights. The cover lens of each module may be removed separately and the bulbs in each module may be replaced without having to disassemble the entire piece.

In addition, U.S. Pat. No. 5,769,532 to Sasaki discloses a LED signaling light made from a plurality of differently colored vertically stacked modules. Each module contains a portion bulged outwardly, which is coated with a reflective material. The LEDs are arranged in rows so that their emitted light is reflected off the reflecting surface and projected into the environment surrounding the module.

Moreover, U.S. Pat. No. 5,929,788 to Vukosic discloses a LED signaling device where clusters of LEDs arranged in rings are mounted on a circuit board and emit light on to a conical reflective surface. The conical reflective surface is outwardly flaring. In order to change to color of the emitted light different colored covers must be manually changed.

Elevated signaling devices are particularly effective in environments where the level of background noise is very high and there is a danger that an audible alarm will not be heard. Furthermore, the elevated signaling devices can distinguish between various malfunctioning conditions by relating different conditions to different colors of lights or to different frequencies of flashing lights. In a crowded factory, a system of elevated signaling devices enables maintenance people to quickly locate and identify specific problems in a large number of operating machines. Such a system is extremely effective and efficient because it enables a single individual to monitor a large number of machines from a distance where the operating status of all the machines can be simultaneously observed.

While these elevated signaling devices have proven to be very effective, they also have various disadvantages. Typical devices are made with a plurality of modules, where each module illuminates a different colored light. A design of one color per single module has numerous disadvantages.

One such disadvantage is when the manufacturing operation takes place in a clean room, such as in the manufacture of semiconductor devices. In order to have better environmental control, it is desirable to reduce the volume of the clean room as much as possible. Industrial signaling devices that employ multiple modules are often too large to be used in clean rooms that have reduced height. Also, multiple module lights have numerous interfaces between the lens of the light and the housing of the electrical components. Each connection interface is a weak spot where water, liquid, dust, corrosive materials, etc. can enter the light and ruin electronic components. Moreover, the manufacture of such multiple module lights is wasteful, and sometimes assembly of the multiple modules is required by the end user. Multiple modules require greater storage space and can be more expensive to handle and ship. They are also more cumbersome to install or service and this can be difficult when the multiple modules are at the end of a pole ten feet or more above a factory floor. Usually, a maintenance person climbs a ladder in order to reach the signaling device.

Accordingly, it is desirable to provide a method and apparatus that has the capability to provide the needed visual signals in a single multi-color changeable device resulting in greater versatility and functionality while maintaining its integrity in a hazardous environment.

### SUMMARY OF THE INVENTION

The foregoing needs are met, to a great extent, by the present invention, wherein in one aspect an apparatus is provided that in some embodiments a single multi-color changeable signal device for use in hazardous or explosive environments is provided.

In accordance with one aspect of the present invention, an explosion-proof industrial signaling device is provided comprising a single lens module; at least one light source contained within the module, wherein the light source includes a plurality of clusters the clusters which are disposed spaced apart from one another, each of the clusters containing lights of different colors which are independently activated such that a signal is seen to be emitting from a signal housing as an individual color.

In accordance with another aspect of the present invention, an explosion-proof industrial signaling device is provided comprising a single module means for protecting a light source, whereby the light source includes a plurality of light clusters, the clusters which are disposed spaced apart from one another, each of the clusters containing lights of different colors which are independently activated such that a signal is seen to be emitting from a signal housing an individual color, and a plurality of light sources disposed in a spaced apart arrangement and located at a focal point of the single module means of the signal housing.

In accordance with still another aspect of the present invention, a method for processing visual indicator signals of an explosion-proof industrial signaling device is provided comprising the steps of utilizing incoming analog information to enable an LED cluster assembly to light, decoding one PLC input to light one LED cluster, and decoding at least two PLC inputs to light at least two LED clusters of differing colors.

There has thus been outlined, rather broadly, certain embodiments of the invention in order that the detailed description thereof herein may be better understood, and in order that the present contribution to the art may be better appreciated. There are, of course, additional embodiments of the invention that will be described below and which will form the subject matter of the claims appended hereto.

In this respect, before explaining at least one embodiment of the invention in detail, it is to be understood that the invention is not limited in its application to the details of construction and to the arrangements of the components set forth in the following description or illustrated in the drawings. The invention is capable of embodiments in addition to those described and of being practiced and carried out in various ways. Also, it is to be understood that the phraseology and terminology employed herein, as well as the abstract, are for the purpose of description and should not be regarded as limiting.

As such, those skilled in the art will appreciate that the conception upon which this disclosure is based may readily be utilized as a basis for the designing of other structures, methods and systems for carrying out the several purposes of the present invention. It is important, therefore, that the claims be regarded as including such equivalent constructions insofar as they do not depart from the spirit and scope of the present invention.

### BRIEF DESCRIPTION OF THE DRAWINGS

FIG. 1 is an exploded view illustrating an explosion-proof visual signal device of a preferred embodiment of the invention.

FIG. 2 is an exploded view of a subassembly of the explosion-proof visual signal device.

FIG. 3 is a diagrammatic view illustrating a wall mounted explosion-proof visual signal device.

FIG. 4 is a diagrammatic view illustrating a ceiling mounted explosion-proof visual signal device.

FIG. 5 is a diagrammatic view illustrating a pendant mounted explosion-proof visual signal device.

FIG. 6 is a schematic of the PLC circuit for the explosion-proof visual signal device.

FIG. 7 is a diagrammatic view illustrating a jumper pin assembly for the explosion-proof visual signal device.

FIG. 8 is a diagrammatic view illustrating the jumper pin assembly of FIG. 6A of the explosion-proof visual signal device.

FIG. 9 is a top view of the LED configuration mounted within the explosion-proof visual signal device.

FIG. 10 is a side view of FIG. 9 along line A-A showing the LED configuration of the explosion-proof visual signal device.

FIG. 11 is a cross-sectional top view of FIG. 2 of the assembled explosion-proof visual signal device.

### DETAILED DESCRIPTION

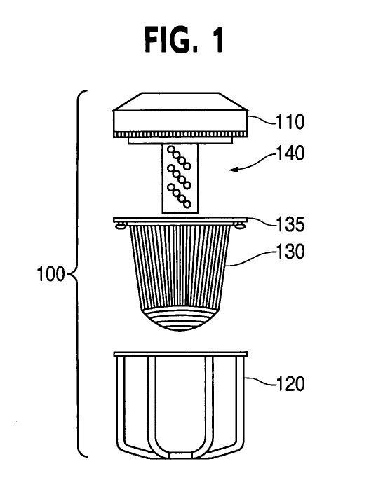

The invention will now be described with reference to the drawing figures, in which like reference numerals refer to like parts throughout. An embodiment of the present inventive apparatus and method is illustrated in FIG. 1. This embodiment in accordance with the present invention provides an explosion-proof multi-color, multi-status signaling device 100 having an effective balance between signal brightness and color identification provided by placing a light emitting diode (LED) light source or cluster 140 in red, blue, and amber or in red, green, and amber in front of a highly reflective material 905 that amplifies and distributes the light output. The LED light source or cluster 140, the reflector 905, and all associated electronics are housed in the top end of a heavy-duty explosion-proof housing 110, preferably made of cast aluminum. This housing 110 is connected to a glass dome or lens 130 via a ring mount 135. The glass dome is preferably made of a polycarbonate material. An exterior guard 120 encased the glass dome 130 to add additional protection.

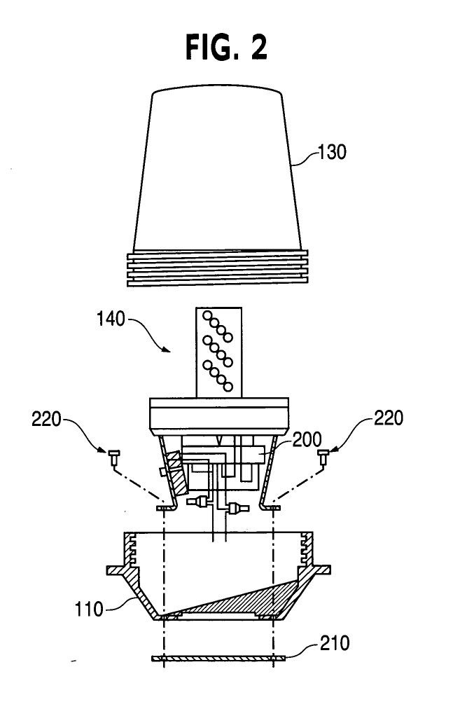

Referring to FIG. 2, the explosion-proof multi-color, multi-status signaling device 100 may be mounted to various types of mounts with mounting screws 220 and gasket 210. A programmable logic control (PLC) unit 200 may be internal to the signaling device 100 in order to operate the LED light cluster 140.

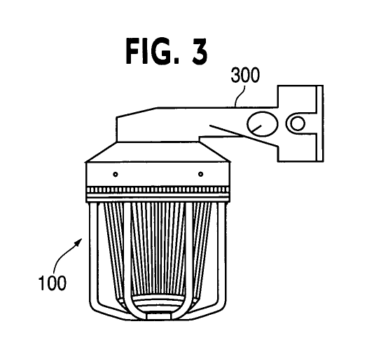

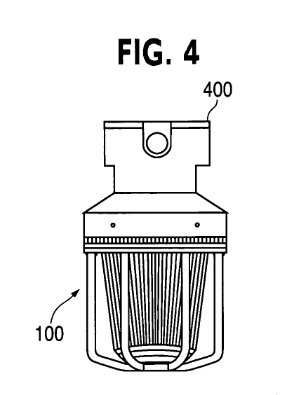

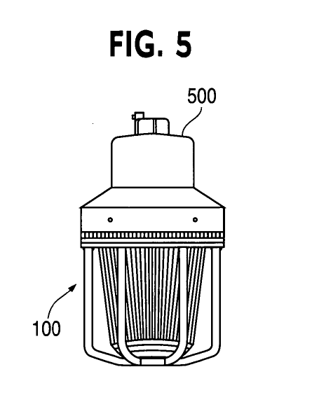

Referring to FIGS. 3-5, it is anticipated that the multi-color, multi-status signaling device 100 including housing 110 may be mounted in at least three arrangements. A wall mount 300 shown in FIG. 3, a ceiling mount 400 shown in FIG. 4, or a pendant mount 500 shown in FIG. 5. These various mounting options may be incumbent upon the required use and location of the multi-color, multi-status signaling device 100.

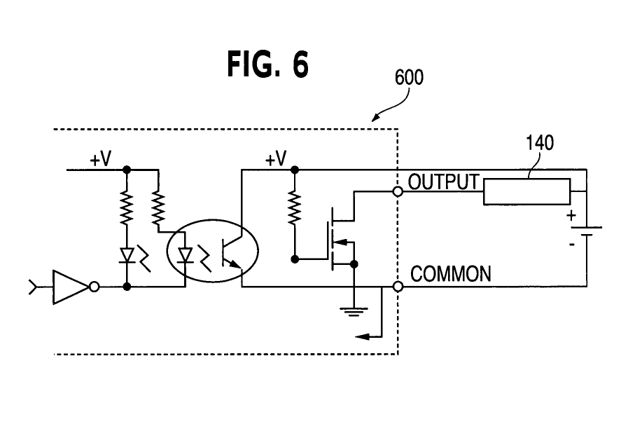

Referring to FIG. 6, the multi-color, multi-status signaling device 100 may be configured with an internal microprocessor PLC sinking output circuit 600 or without an internal microprocessor PLC circuit utilizing instead an external PLC (not shown). The embodiment of the multi-color, multi-status signaling device 100 having the internal microprocessor PLC sinking output circuit 600 interprets incoming analog information to enable the LED light cluster 140 to light according to the input or information provided.

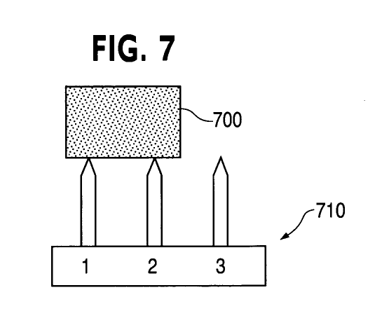

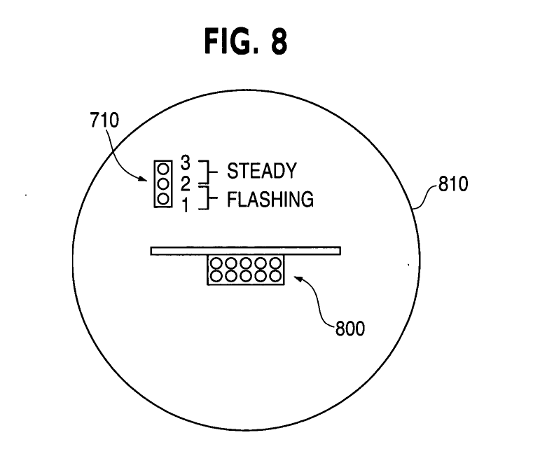

Referring to FIGS. 7 and 8, the multi-color, multi-status signaling device 100 may also have an internal jumper 700 with associated jumper pins 710 connected to a circuit board 810 having a circuit board power connector interface 800. This jumper 700 may allow the first selected light to illuminate as either a steady or flashing light. For example, if jumper pins 710 has jumper 700 on pins 1 and 2 a flashing light may be enabled while having jumper 700 on pins 2 and 3 enables a steady light configuration.

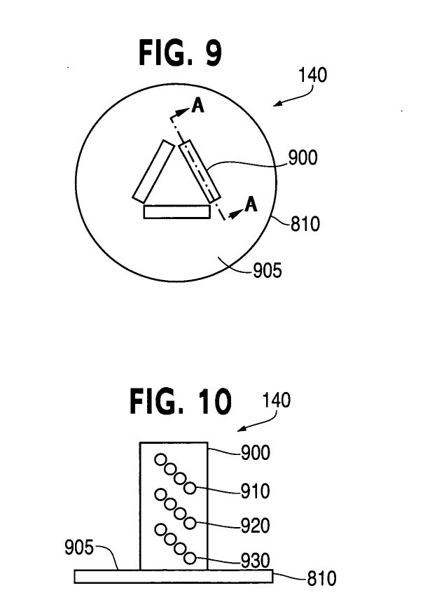

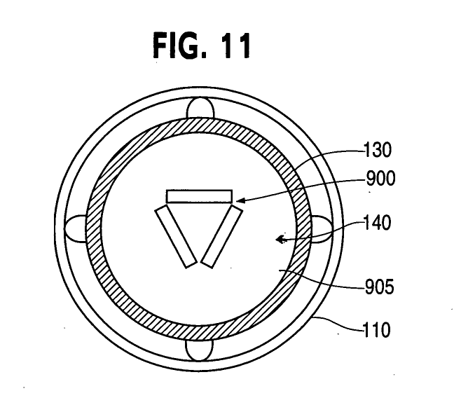

Referring to FIGS. 9-11, the LED light source or cluster 140 may include a printed circuit board 900 connected to circuit board 810 and configured as a three-sided vertical structure to illuminate the LED light cluster 140 in a 360° hemi-spherical range. A reflective material 905 is disposed adjacent to LED light cluster 140 to increase the illumination upon activation of LED light cluster 140. The printed circuit board contains an array of red LEDs 910, an array of blue or green LEDs 920 and an array of amber LEDs 930.

The explosion-proof visual signal device 100 provides a rugged case enclosing the necessary elements of proper operation of the signal lights and isolating these elements from any explosive external atmosphere which may exist via glass dome 130.

In operation, the internal microprocessor embodiment utilizes incoming analog information to cause the LED light cluster 140 to illuminate. For example, if the microprocessor PLC unit 200 detects one contact closure for PLC input, then one selected LED cluster 910, 920, or 930 will illuminate. If two or more PLC inputs or contact closures are received, then microprocessor PLC unit 200 decodes this information and causes the light to cycle between two or more selected LED clusters 910, 920, or 930.

In an alternative use for the present invention, it should be noted that the housing 110 may be moisture-proof allowing the signal lights or cluster 140 to be used in damp environments or outdoors where various weather conditions may occur.

In another embodiment, the multi-color, multi-status signaling device 100 without the internal microprocessor PLC unit 200 functions in the same manner as the signaling device 100 with the microprocessor PLC unit 200 with the exception that all functionality is controlled by inputs from an external PLC (not shown). Therefore, each color of the LED light source or cluster 140 can be separately activated through an external contact closure or input from an external industrial programmable logic controller.

The many features and advantages of the invention are apparent from the detailed specification, and thus, it is intended by the appended claims to cover all such features and advantages of the invention which fall within the true spirit and scope of the invention. Further, since numerous modifications and variations will readily occur to those skilled in the art, it is not desired to limit the invention to the exact construction and operation illustrated and described, and accordingly, all suitable modifications and equivalents may be resorted to, falling within the scope of the invention.

What is claimed is:

1. An explosion-proof industrial signaling device comprising:
a housing;
a single lens module mounted to said housing; and
at least one light source contained within said module, wherein said light source includes a plurality of light clusters said clusters are disposed spaced apart from one another, each of said clusters containing lights of different colors which can be independently activated such that a signal is seen to be emitting from a signal housing as an individual color.

2. The explosion-proof industrial signaling device according to claim 1, wherein said light source is configured to alternately illuminate as either a steady light or a flashing light.

3. An explosion-proof signaling device according to claim 1, further comprising a microprocessor, whereby said microprocessor interprets incoming information and separately activates each differently colored light source.

4. The explosion-proof industrial signaling device according to claim 1, further comprising a programmable logic controller.

5. The explosion-proof industrial signaling device according to claim 1, comprising at least three differently colored light sources.

6. The explosion-proof industrial signaling device of claim 1, wherein said single module comprises a polycarbonate material.

7. The explosion-proof industrial signaling device of claim 1, wherein said housing is cast aluminum.

8. The explosion-proof industrial signaling device of claim 1, wherein said single module comprises a lens comprising a plastic and a fiber.

9. The explosion-proof industrial signaling device of claim 1, wherein said light source is a plurality of light emitting diodes.

10. The explosion-proof industrial signaling device of claim 1, where said light source is a plurality of light emitting diodes mounted on a circuit board post.

11. The explosion-proof industrial signaling device of claim 1, wherein said light emitting diodes are disposed above a reflective material within said single module.

12. The explosion-proof industrial signaling device of claim 1, further comprising a cover and a base, wherein there is a single interface between said cover and said base.

13. A method for processing visual indicator signals of an explosion-proof industrial signaling device is provided comprising the steps of:
utilizing incoming analog information to enable a light emitting diode cluster to illuminate;
decoding one programmable logic control input to illuminate one light emitting diode cluster of the same color; and
decoding at least two programmable logic control inputs to illuminate at least two light emitting diode clusters of differing colors.

14. The method of claim 13, wherein said decoding step utilizes a sinking output circuit in the programmable logic control.

15. An explosion-proof industrial signaling device comprising:
a single module means for protecting a light source, whereby said light source includes a plurality of clusters of lights, said clusters which are disposed spaced apart from one another in layers, each of said clusters containing lights of different colors which can be independently activated such that a signal is seen to be emitting from a signal housing as an individual color, and a plurality of light sources disposed in a spaced apart arrangement and located at a focal point of said single module means of said signal housing.

16. The explosion-proof industrial signaling device according to claim 15, wherein said light sources can alternately illuminate as either a steady or a flashing light source.

17. The explosion-proof industrial signaling device according to claim 15, further comprising a processor means, whereby said processor means interprets incoming information and separately activates each different colored light source.

18. The explosion-proof industrial signaling device according to claim 15, further comprising a programmable logic controller means.

19. The explosion-proof industrial signaling device according to claim 15, wherein said light source emits lights of at least three different colors.

20. The explosion-proof industrial signaling device of claim 15, further comprising a reflective means mounted beneath said light source.
